(19) United States
(12) Patent Application Publication
(10) Pub. No.: US 2014/0225809 A1
(43) Pub. Date: Aug. 14, 2014

(54) METHOD, SYSTEM, AND DEVICE FOR GENERATING, DISTRIBUTING, AND MAINTAINING MOBILE APPLICATIONS

(71) Applicant: DGSJ NETWORK INC., New York, NY (US)

(72) Inventors: Ethan Fletcher, Brooklyn, NY (US); Daniel Wyszynski, Staten Island, NY (US); David S. Bennahum, Forest Hills, NY (US)

(21) Appl. No.: 14/117,185

(22) PCT Filed: Mar. 29, 2013
(86) PCT No.: PCT/US2013/034633

§ 371 Date: Nov. 12, 2013

Related U.S. Application Data
(60) Provisional application No. 61/618,815, filed on Apr. 1, 2012.

(51) Int. Cl. G06F 3/14

(52) U.S. Cl. CPC G06F 3/14
USPC 345/2.2

(57) ABSTRACT

A method, device, and system for generating, maintaining, and distributing mobile applications may include executing a master mobile application on a mobile computing device and displaying a plurality of icons on a display of the mobile computing device. Each icon represents a secondary mobile application that may be invoked from the master mobile application upon selection by a user. Upon section, the corresponding secondary mobile application is executed from the master mobile application.

### CROSS-REFERENCE TO RELATED U.S. PATENT APPLICATION

This present application claims priority under 35 U.S.C. §119(e) to U.S. Provisional Application Ser. No. 61/618,815, entitled “METHOD, SYSTEM, AND DEVICE FOR GENERATING, DISTRIBUTING, AND MAINTAINING MOBILE APPLICATIONS” by FLETCHER, Ethan, et al., which was filed on Apr. 1, 2013, the entirety of which is hereby incorporated by reference.

### TECHNICAL FIELD

The present disclosure relates, generally, to applications for mobile computing devices and, more particularly, to methods, systems and devices for generating, distributing, and maintaining mobile applications.

### BACKGROUND

Mobile applications are relatively small software applications designed for and executed on mobile computing devices, small form factor computers, and other low-power handheld computing devices such as smartphones, tablet computers, and laptop computers. A computing device may have multiple mobile applications stored thereon, each selectively executable on a mobile operating system of the computing device. In many implementations, the mobile applications may be obtained and updated from a remote data server. For example, the computing device may download the mobile application, or an update of the mobile application, from such remote data servers over a network.

In some cases, the distribution and availability of mobile applications for certain devices and/or mobile operating systems is controlled by a third party. Such third parties may provide a single point of access, such as an online store, for a large number of mobile applications. Additionally, the third party may provide increased security and quality of mobile applications by reviewing and authorizing mobile applications prior to making the mobile applications available for download in such online stores.

### SUMMARY

According to one aspect, a method for executing a mobile application on a mobile computing device may include executing a master mobile application on a mobile computing device, displaying a plurality of icons on a display of the mobile computing device, each icon representing a secondary mobile application that may be invoked from the master mobile application, and executing a secondary mobile application from the master mobile application in response to a user selecting a corresponding icon of the plurality of icons. The method may also include displaying a plurality of icons on the display of the mobile computing device comprises displaying a virtual shelf and displaying the plurality of icons on the virtual shelf. Additionally, the method may include detecting a user's interaction with the virtual shelf and moving the virtual shelf to display additional secondary mobile applications available for selection by the user. The method may further include displaying date information in association with each secondary mobile application indicative of the last update date of the corresponding secondary mobile application. Additionally, the method may include detecting a user's interaction with a selected secondary mobile application displayed on the virtual shelf and in response to the user's interaction matching a predetermined interaction, displaying text information regarding the selected secondary mobile application in place of the icon corresponding to the selected secondary mobile application.

In some embodiments, executing the secondary mobile application may include communicating with a remote server over a network to service the secondary mobile application. Additionally, executing the secondary mobile application may include downloading a secondary mobile application from a remote server. In some embodiments, executing a secondary mobile application may include executing a secondary content mobile application. Additionally or alternatively, executing a secondary mobile application comprises executing a secondary advertisement mobile application.

In some embodiments, the method may also include generating user behavior data on the mobile computing device associated with at least one secondary mobile application and transmitting the generated user behavior data to the remote server. Additionally, the method may include receiving an updated secondary mobile application from a remote server and storing the updated secondary mobile application on the mobile computing device. The method may further include receiving an update notification from a remote server, communicating with the remote server in response to the update notification, and retrieving an updated secondary mobile application from the remote server.

According to another aspect, a mobile computing device may include a processor and a memory device communicatively coupled to the processor. The memory device may have a plurality of instructions stored therein that result in the processor executing a master mobile application on the mobile computing device, displaying a plurality of icons on a display of the mobile computing device, each icon representing a secondary mobile application that may be invoked from the master mobile application, and executing a secondary mobile application from the master mobile application in response to a user selecting a corresponding icon of the plurality of icons. The processor may also display a plurality of icons on the display of the mobile computing device comprises displaying a virtual shelf and display the plurality of icons on the virtual shelf. Additionally, the processor may detect a user's interaction with the virtual shelf and moving the virtual shelf to display additional secondary mobile applications available for selection by the user. The processor may further display date information in association with each secondary mobile applications indicative of the last update date of the corresponding secondary mobile application. Additionally, the processor may detect a user's interaction with a selected secondary mobile application displayed on the virtual shelf and in response to the user's interaction matching a predetermined interaction, display text information regarding the selected secondary mobile application in place of the icon corresponding to the selected secondary mobile application.

In some embodiments, the plurality of instructions may further result in the processor communicating with a remote server over a network to service the secondary mobile application. Additionally, the plurality of instructions may result in the processor downloading a secondary mobile application from a remote server. In some embodiments, the secondary mobile application may comprise a secondary content mobile application. Additionally or alternatively, the secondary mobile application may comprise a secondary advertisement mobile application.

In some embodiments, the processor may also generate user behavior data on the mobile computing device associated with at least one secondary mobile application and transmit the generated user behavior data to the remote server. Additionally, the processor may receive an updated secondary mobile application from a remote server and store the updated secondary mobile application on the mobile computing device. The processor may also receive an update notification from a remote server, communicate with the remote server in response to the update notification, and retrieve an updated secondary mobile application from the remote server.

According to a further aspect, at least one machine readable media may comprise a plurality of instructions, which in response to being executed by a mobile computing device, result in the mobile computing device executing a master mobile application on the mobile computing device, displaying a plurality of icons on a display of the mobile computing device, each icon representing a secondary mobile application that may be invoked from the master mobile application, and executing a secondary mobile application from the master mobile application in response to a user selecting a corresponding icon of the plurality of icons. The computing device may also display a plurality of icons on the display of the mobile computing device comprises displaying a virtual shelf and display the plurality of icons on the virtual shelf. Additionally, the computing device may detect a user's interaction with the virtual shelf and moving the virtual shelf to display additional secondary mobile applications available for selection by the user. The computing device may further display date information in association with each secondary mobile applications indicative of the last update date of the corresponding secondary mobile application. Additionally, the computing device may detect a user's interaction with a selected secondary mobile application displayed on the virtual shelf and in response to the user's interaction matching a predetermined interaction, display text information regarding the selected secondary mobile application in place of the icon corresponding to the selected secondary mobile application.

In some embodiments, the plurality of instructions may further result in the computing device communicating with a remote server over a network to service the secondary mobile application. Additionally, the plurality of instructions may result in the computing device downloading a secondary mobile application from a remote server. In some embodiments, the secondary mobile application may comprise a secondary content mobile application. Additionally or alternatively, the secondary mobile application may comprise a secondary advertisement mobile application.

In some embodiments, the computing device may also generate user behavior data on the mobile computing device associated with at least one secondary mobile application and transmit the generated user behavior data to the remote server. Additionally, the computing device may receive an updated secondary mobile application from a remote server and store the updated secondary mobile application on the mobile computing device. The computing device may also receive an update notification from a remote server, communicate with the remote server in response to the update notification, and retrieve an updated secondary mobile application from the remote server.

### BRIEF DESCRIPTION OF THE DRAWINGS

FIG. 1 is simplified block diagram of at least one embodiment of a system for generating, distributing, and maintaining mobile applications;

FIG. 2 is a simplified block diagram of at least one embodiment of a content management client of the system of FIG. 1;

FIG. 3 is a simplified block diagram of at least one embodiment of a content server of the system of FIG. 1;

FIG. 4 is a simplified block diagram of at least one embodiment of a client computing device of the system of FIG. 1;

FIG. 5 is a simplified flow diagram of at least one embodiment of a method for generating and updating mobile applications that may be executed by the content management client of FIG. 1;

FIG. 6 is a simplified flow diagram of at least one embodiment of a method for maintaining and updating mobile applications that may be executed by the content server of FIG. 1;

FIG. 7 is a simplified flow diagram of at least one embodiment of a method for servicing mobile applications that may be executed by the content server of FIG. 1;

FIG. 8 is a simplified flow diagram of at least one embodiment of a method for retrieving, updating, and executing mobile applications that may be executed by the client computing device of FIG. 1; and

FIGS. 9-12 are illustrative embodiments of screenshots that may be displayed to a user of the client computing device of FIG. 1 during executing of the method of FIG. 8.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

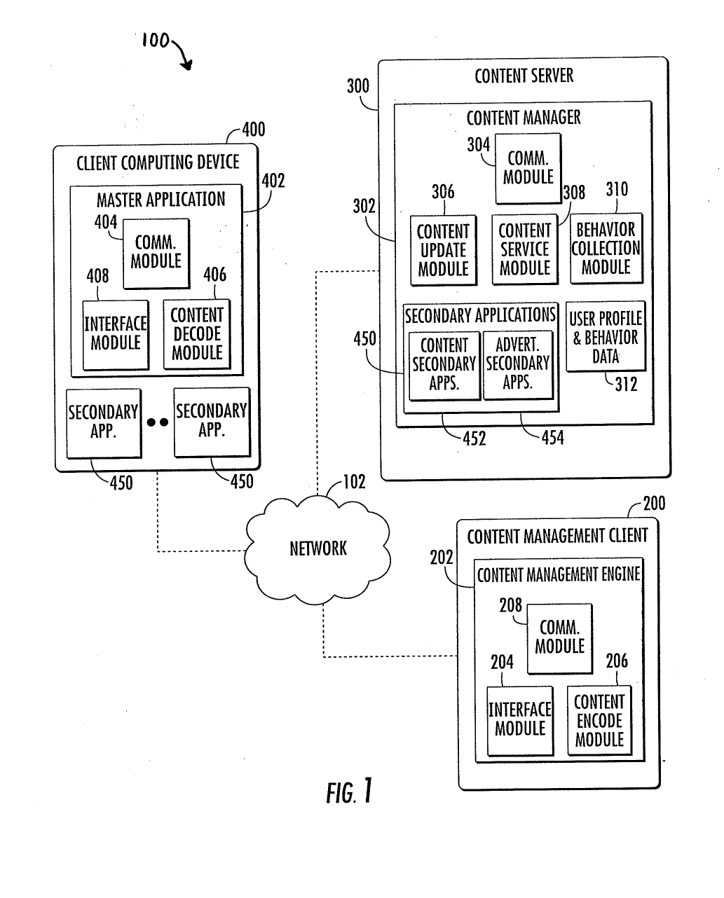

Referring now to FIG. 1, a system 100 for generating, distributing, maintaining, and executing mobile applications includes a content management client 200, a content server 300, and a client computing device 400, which communicate with each other over a network 102. In use, a mobile software application developer may operate the content management client 200 to develop, update, and manage mobile applications for use on the client computing device 400. Once developed or updated, the mobile applications may be transmitted from the content management client 200 to the content server 300 for storage and distribution to the one or more client computing devices 400.

In the illustrative embodiment, the content management client 200 may be used to develop and update secondary mobile applications 450, which may be invoked or otherwise executed by a master application 402 executed on the client computing device 400 as discussed in more detail below. The secondary mobile applications 450 may be stored on the content server 300 and retrieved therefrom periodically or on an as-needed basis. Because the secondary applications 450 are invoked from within the master application 402, only the master application 402 need be verified and/or authorized for distribution on the present platform. For example, in implementations wherein the distribution and/or execution of mobile applications is controlled or otherwise screened by a third-party, only the master application 402 need be submitted to such authorization processes. Conversely, the secondary applications 450 may be developed, updated, and distributed without submitting such secondary application to the authorization process because the secondary applications are executed from within the master application 402, rather than typical stand-alone application. As such, it should be appreciated that the development, distribution, and maintained of new and updated secondary applications 450 may be, in some embodiments, quicker, more efficient, and less costly than typical new, stand-alone mobile applications.

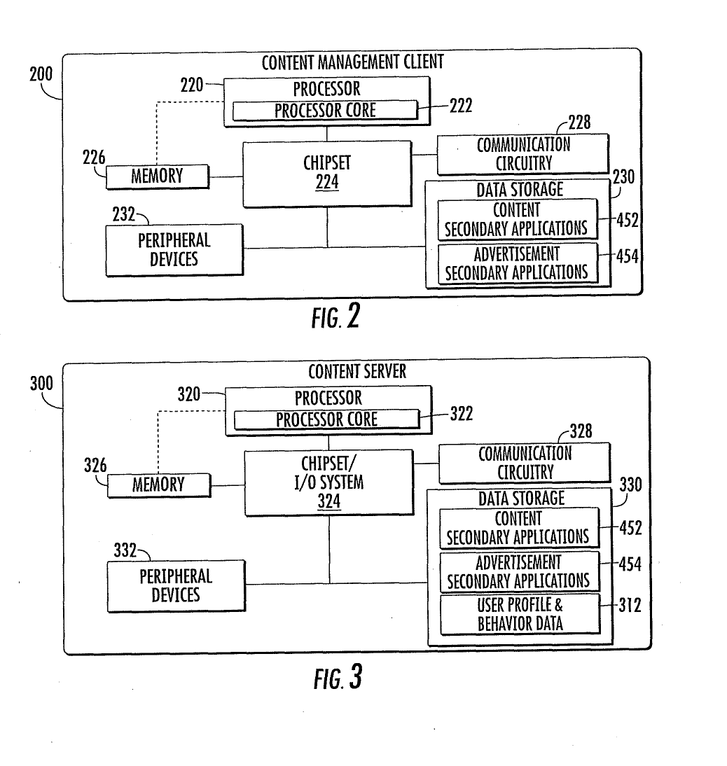

The content management client 200 may be embodied as any type of computing device, such as a desktop computer, a laptop computer, a tablet computer, or the like, capable of performing the functions described herein. In one illustrative embodiment as illustrated in FIG. 2, the content management client 200 includes a processor 220, a chipset 224, a memory 226, communication circuitry 228, a data storage device 230, and one or more peripheral devices 232. In some embodiments, several of the foregoing components may be incorporated on a motherboard of the content management client 200, while other components may be communicatively coupled to the motherboard via, for example, a peripheral port. Furthermore, it should be appreciated that the content management client 200 may include other components, sub-components, and devices commonly found in a computing device, which are not illustrated in FIG. 2 for clarity of the description.

The processor 220 of the content management client 200 may be embodied as any type of processor capable of executing software/firmware, such as a microprocessor, digital signal processor, microcontroller, or the like. The processor 220 is illustratively embodied as a single core processor having a processor core 222. However, in other embodiments, the processor 220 may be embodied as a multi-core processor having multiple processor cores 222. Additionally, the content management client 200 may include additional processors 220 having one or more processor cores 222.

The chipset 224 of the content management client 200 may be embodied as circuitry and/or components to facilitate input/output operations with the processor 220 and/or other components of the content management client 200. In some embodiments, the chipset 224 may be embodied as a memory controller hub (MCH or “northbridge”), an input/output controller hub (ICH or “southbridge”), and a firmware device. In such embodiments, the firmware device of the chipset 224 may be embodied as a memory device for storing Basic Input/Output System (BIOS) data and/or instructions and/or other information (e.g., a BIOS driver used during booting of the content management client 200). However, in other embodiments, chipsets having other configurations may be used. For example, in some embodiments, the chipset 224 may be embodied as a platform controller hub (PCH). In such embodiments, the memory controller hub (MCH) may be incorporated in or otherwise associated with the processor 220, and the processor 220 may communicate directly with the memory 226.

The processor 220 is communicatively coupled to the chipset 224 via a number of signal paths. These signal paths (and other signal paths illustrated in FIG. 2) may be embodied as any type of signal paths capable of facilitating communication between the components of the content management client 200. For example, the signal paths may be embodied as any number of wires, cables, light guides, printed circuit board traces, via, bus, intervening devices, and/or the like.

The memory 226 of the content management client 200 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 226 is communicatively coupled to the chipset 224 via a number of signal paths. Although only a single memory device 226 is illustrated in FIG. 2, the content management client 200 may include additional memory devices in other embodiments. Various data and software may be stored in the memory device 226. For example, one or more operating systems, applications, programs, libraries, and drivers that make up the software stack executed by the processor 220 may reside in memory 226 during execution. Furthermore, software and data stored in memory 226 may be swapped between the memory 226 and the data storage 230 as part of memory management operations.

The communication circuitry 228 of the content management client 200 may be embodied as any number of devices and circuitry for enabling communications between the content management client 200 and remote computing devices (e.g., the content server 300) over the network 102. The network 102 may be embodied as any number of various wired and/or wireless communication networks. For example, the network 102 may be embodied as or otherwise include a local area network (LAN), a wide area network (WAN), or a publicly-accessible, global network such as the Internet. Additionally, the network 102 may include any number of additional devices to facilitate communication between the content management client 200, the content server 300, and the client computing device(s) 400. The content management client 200, the content server 300, and the client computing device(s) 400 may use any suitable communication protocol to communicate with each other over the network 102 depending on, for example, the particular type of network(s) 102.

The data storage device(s) 230 may be embodied as any type of device or devices configured for the short-term or long-term storage of data such as, for example, memory devices and circuits, memory cards, hard disk drives, solid-state drives, or other data storage devices. In some embodiments, the data storage device 230 may form a part of the content management client 200. However, in other embodiments, the data storage device 230 may be separate from the content management client 200 but in communication therewith. For example, in some embodiments, the data storage device 230 may be embodied as a database server. Additionally, as illustrated in FIG. 2, the data storage device 230 may include one or more secondary mobile applications 450 during the process of development of such applications. As discussed in more detail below, the secondary mobile applications 450 may be embodied as content secondary applications 452 or advertisement secondary applications 454. Such content secondary applications 452 may include any type of content applications such as an information, news, periodical, game, or other content application. Similarly, the advertisement secondary applications 454 may include any type of advertisement applications such as product or service advertisements, which may be static, animated, or interactive.

The peripheral devices 232 of the content management client 200 may include any number of peripheral or interface devices. For example, the peripheral devices 232 may include a display, a keyboard, a mouse, external speakers, and/or other peripheral devices. The peripheral devices 232 are communicatively coupled to the chipset 224 via a number of signal paths thereby allowing the chipset 224 and/or processor 220 to receive inputs from and send outputs to the peripheral devices 232.

Referring back to FIG. 1, as discussed above, the content management client 200 may be used to develop new or updated secondary applications. To do so, the content management client 200 may include a content management engine 202, which may be embodied as software, hardware, or a combination of software and hardware. For example, in some embodiments, the content management engine 202 may be embodied as a suite of software development applications. The content management engine 202 facilitates the development and distribution of mobile applications. In the illustrative embodiment, the content management engine 202 includes an interface module 204, which may be embodied as, or otherwise include, a graphical user interface (GUI), an object-oriented interface, browser-based interface, or other programming interface to facilitate the development of mobile applications. Once developed, the new or updated secondary mobile application 450 may be encoded by a content encode module 206 of the content management engine 202. The content encode module 206 may be configured to encode the secondary mobile application 450 to a proprietary or other specialized format for execution by the master application 402 of the client computing device 400. Subsequently, a communication module 208 of the content management engine 202 may upload or otherwise transmit the completed secondary mobile application 450 to the content server 300 for distribution to the one or more client computing devices 400.

Of course, it should be appreciated that the interface module 204, the content encode module 206, and the communication module 208 are merely illustrative and, in other embodiments, the content management engine 202 may include additional, fewer, or other modules. Additionally, it should be appreciated that the content management engine 202 may use any underlying development software to facilitate the development of the secondary mobile applications 450 such as, for example, Drupal™, C++, or the like. Additionally, in some embodiments, the content management engine may be hosted by the content server 300 or other server, rather than on the local content management client 200. In such embodiments, the content management client 200 may access the content server 300 or other server to develop or update the secondary mobile applications 450 as discussed above using, for example, a browser-based interface.

As discussed above, the content server 300 is configured to store and distribute the secondary applications 450 to the one or more client computing devices 400. The content server 300 may be embodied as any type server capable of performing the functions described herein. In one illustrative embodiment as illustrated in FIG. 3, the content server 300 includes a processor 320, a chipset 324, a memory 326, communication circuitry 328, a data storage device 330, and one or more peripheral devices 332. In some embodiments, several of the foregoing components may be incorporated on a motherboard of the content server 300, while other components may be communicatively coupled to the motherboard via, for example, a peripheral port. Furthermore, it should be appreciated that the content server 300 may include other components, sub-components, and devices commonly found in a data server, which are not illustrated in FIG. 3 for clarity of the description.

The processor 320 of the content server 300 may be embodied as any type of processor capable of executing software/firmware, such as a microprocessor, digital signal processor, microcontroller, or the like. The processor 320 is illustratively embodied as a single core processor having a processor core 322. However, in other embodiments, the processor 320 may be embodied as a multi-core processor having multiple processor cores 222. Additionally, the content server 300 may include additional processors 320 having one or more processor cores 322.

The chipset 324 of the content server 300 may be embodied as circuitry and/or components to facilitate input/output operations with the processor 320 and/or other components of the content server 300. In some embodiments, the chipset 324 may be embodied as a memory controller hub (MCH or “northbridge”), an input/output controller hub (ICH or “southbridge”), and a firmware device. In such embodiments, the firmware device of the chipset 324 may be embodied as a memory device for storing Basic Input/Output System (BIOS) data and/or instructions and/or other information (e.g., a BIOS driver used during booting of the content server 300). However, in other embodiments, chipsets having other configurations may be used. For example, in some embodiments, the chipset 324 may be embodied as a platform controller hub (PCH). In such embodiments, the memory controller hub (MCH) may be incorporated in or otherwise associated with the processor 320, and the processor 320 may communicate directly with the memory 326.

The processor 320 is communicatively coupled to the chipset 324 via a number of signal paths. These signal paths (and other signal paths illustrated in FIG. 3) may be embodied as any type of signal paths capable of facilitating communication between the components of the content server 300. For example, the signal paths may be embodied as any number of wires, cables, light guides, printed circuit board traces, via, bus, intervening devices, and/or the like.

The memory 326 of the content server 300 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 326 is communicatively coupled to the chipset 324 via a number of signal paths. Although only a single memory device 326 is illustrated in FIG. 3, the content server 300 may include additional memory devices in other embodiments. Various data and software may be stored in the memory device 326. For example, one or more operating systems, applications, programs, libraries, and drivers that make up the software stack executed by the processor 320 may reside in memory 326 during execution. Furthermore, software and data stored in memory 326 may be swapped between the memory 326 and the data storage 330 as part of memory management operations.

The communication circuitry 328 of the content server 300 may be embodied as any number of devices and circuitry for enabling communications between the content server 300 and remote computing devices (e.g., the content management client 200 and the one or more client computing devices 400) over the network 102. The data storage device(s) 330 may be embodied as any type of device or devices configured for the short-term or long-term storage of data such as, for example, memory devices and circuits, memory cards, hard disk drives, solid-state drives, or other data storage devices. In some embodiments, the data storage device 330 may form a part of the content server 300. However, in other embodiments, the data storage device 330 may be separate from the content server 300 but in communication therewith.

Additionally, as illustrated in FIG. 3, the data storage device 330 may include one or more secondary mobile applications 450 for distribution and/or updating to the client computing devices 400. As discussed above, the secondary mobile applications 450 may be embodied as content secondary applications 452 or advertisement secondary applications 454. In some embodiments, as discussed in more detail below, the content server 300 may also be configured to collect user profile and behavior data based on the user's interaction with the master application 402 and the secondary applications 450. In such embodiments, the data storage 330 may also include or otherwise store user profile and behavior data 312.

The peripheral devices 332 of the content server 300 may include any number of peripheral or interface devices. For example, the peripheral devices 332 may include a display, a keyboard, a mouse, external speakers, and/or other peripheral devices. The peripheral devices 332 are communicatively coupled to the chipset 324 via a number of signal paths thereby allowing the chipset 324 and/or processor 320 to receive inputs from and send outputs to the peripheral devices 332.

Referring back to FIG. 1, as discussed above, the content server 300 stores, distributes, and updates the secondary applications 450. To do so, the content server 300 may include a content manager 302, which may be embodied as software, hardware, or a combination software and hardware. For example, in some embodiments, the content manager 302 may be embodied as a collection of separate software/hardware applications that communicate with each other to perform the functions described herein. In the illustrative embodiment, the content manager 302 includes a communication module 304, which is configured to communicate with the content management client 200 and the client computing devices 400.

The content manager 302 may also include a content update module 306, which is configured to receive the updated or new secondary applications 450 from the content management client 200 via the communication module 304. Additionally, the content update module 306 is configured to distribute the new or updated secondary applications 450 to the client computing device 400. To do so, in some embodiments, the content update module 306 may “push” the new or updated secondary modules 450 to the client computing devices 400 by, for example, sending a notification that such new or updated secondary modules 450 are available. In some embodiments, the content manager 302 may also include a content service module 308 that is configured to service the master application 402 and/or secondary applications 450 executed by the client computing device 400. For example, some secondary applications 450 may require additional services and/or data during execution. Additionally, in some embodiments, the secondary application 450, or a portion thereof, may not be stored locally on the client computing device 400. In such embodiments, the content service module 308 may update or otherwise provide the secondary application 450, or required portion thereof, to the client computing device 400 on an as-needed basis.

In some embodiments, the content manager may also include a behavior collection module 310. The behavior collection module 310 is configured to collect user profile data and associated user behavioral data 312 from the client computing devices 400. The behavior collection module 310 may store the user profile and behavior data 312 in a database. The behavior data is associated with the master application 402 and/or the secondary applications 450 and may be used for advertisement sales, selection, and distribution purposes. For example, in some embodiments, the behavior data may be used to select which advertisement secondary applications 454 to send to a particular client computing device 400.

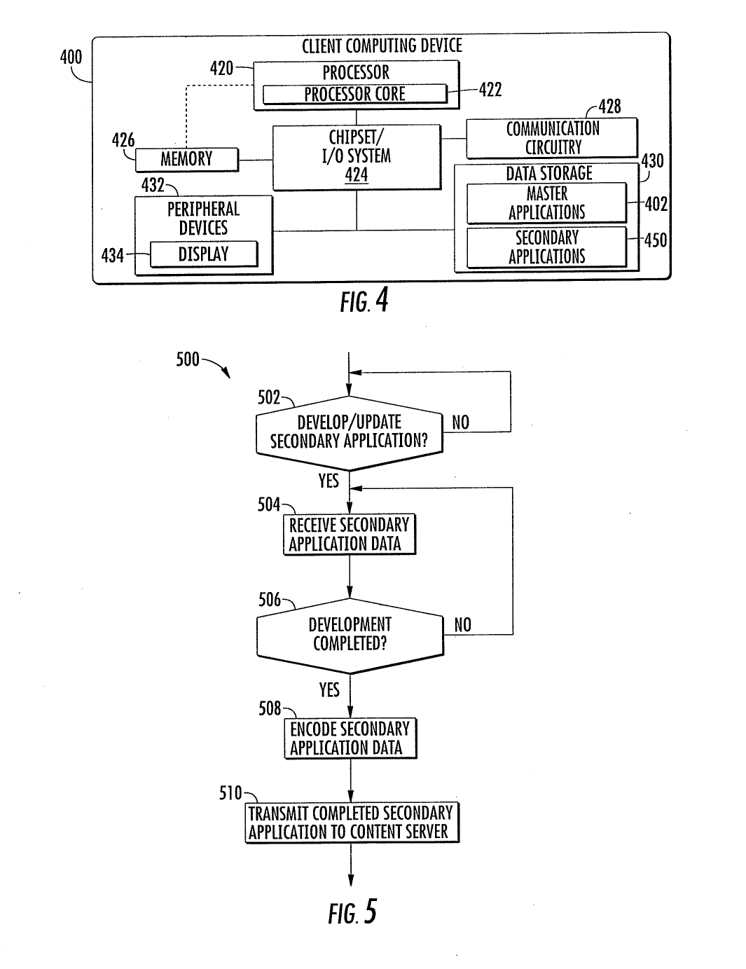

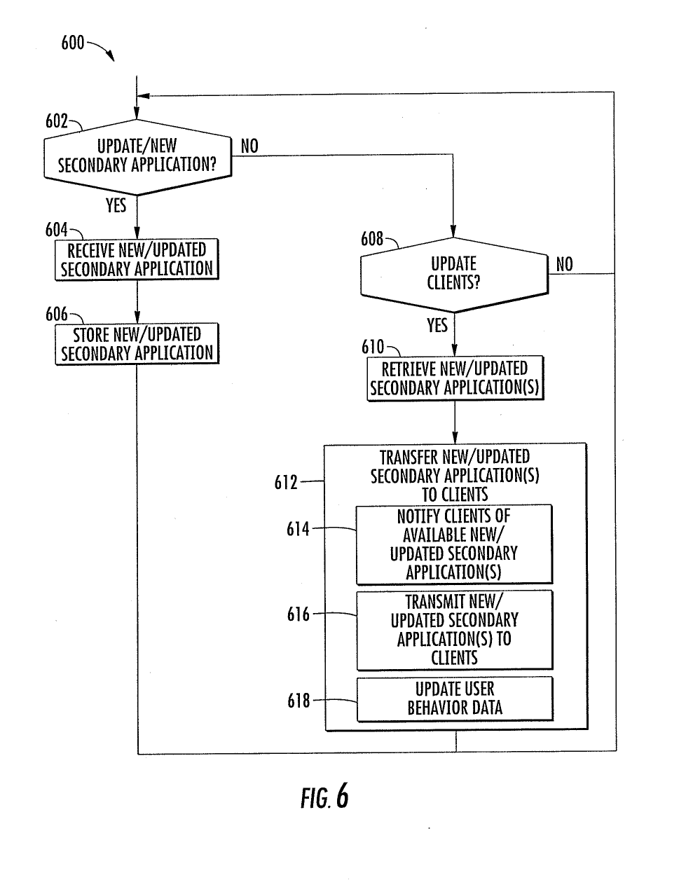

As discussed above, the client computing device 400 executes the master application 402 and the secondary applications 450 as discussed in more detail blow. The client computing device 400 may be embodied as any type of mobile computing devices, such as a tablet computer, smart phone, laptop computer, or other mobile computing device, capable of performing the functions described herein. In one illustrative embodiment as illustrated in FIG. 4, the client computing device 400 includes a processor 420, a chipset 424, a memory 426, communication circuitry 428, a data storage device 430, and one or more peripheral devices 432. In some embodiments, several of the foregoing components may be incorporated on a motherboard of the client computing device 400, while other components may be communicatively coupled to the motherboard via, for example, a peripheral port. Furthermore, it should be appreciated that the client computing device 400 may include other components, sub-components, and devices commonly found in a mobile computing device, which are not illustrated in FIG. 4 for clarity of the description.

The processor 420 of the client computing device 400 may be embodied as any type of processor capable of executing software/firmware, such as a microprocessor, digital signal processor, microcontroller, or the like. The processor 420 is illustratively embodied as a single core processor having a processor core 422. However, in other embodiments, the processor 420 may be embodied as a multi-core processor having multiple processor cores 422. Additionally, the client computing device 400 may include additional processors 420 having one or more processor cores 422.

The chipset 424 of the client computing device 400 may be embodied as circuitry and/or components to facilitate input/output operations with the processor 420 and/or other components of the client computing device 400. In some embodiments, the chipset 424 may be embodied as a memory controller hub (MCH or “northbridge”), an input/output controller hub (ICH or “southbridge”), and a firmware device. In such embodiments, the firmware device of the chipset 424 may be embodied as a memory device for storing Basic Input/Output System (BIOS) data and/or instructions and/or other information (e.g., a BIOS driver used during booting of the client computing device 400). However, in other embodiments, chipsets having other configurations may be used. For example, in some embodiments, the chipset 424 may be embodied as a platform controller hub (PCH). In such embodiments, the memory controller hub (MCH) may be incorporated in or otherwise associated with the processor 420, and the processor 420 may communicate directly with the memory 426.

The processor 420 is communicatively coupled to the chipset 424 via a number of signal paths. These signal paths (and other signal paths illustrated in FIG. 4) may be embodied as any type of signal paths capable of facilitating communication between the components of the client computing device 400. For example, the signal paths may be embodied as any number of wires, cables, light guides, printed circuit board traces, via, bus, intervening devices, and/or the like.

The memory 426 of the client computing device 400 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 426 is communicatively coupled to the chipset 424 via a number of signal paths. Although only a single memory device 426 is illustrated in FIG. 4, the client computing device 400 may include additional memory devices in other embodiments. Various data and software may be stored in the memory device 426. For example, one or more operating systems, applications, programs, libraries, and drivers that make up the software stack executed by the processor 420 may reside in memory 426 during execution. Furthermore, software and data stored in memory 426 may be swapped between the memory 426 and the data storage 430 as part of memory management operations.

The communication circuitry 428 of the client computing device 400 may be embodied as any number of devices and circuitry for enabling communications between the client computing device 400 and remote computing devices (e.g., the content server 300) over the network 102. The data storage device(s) 430 may be embodied as any type of device or devices configured for the short-term or long-term storage of data such as, for example, memory devices and circuits, memory cards, hard disk drives, solid-state drives, or other data storage devices. As shown in FIG. 4, the data storage device 430 may store the master application 402 and one or more secondary applications 450, which may be embodied as content secondary applications 452 or advertisement secondary applications 454.

The peripheral devices 432 of the client computing device 400 may include any number of peripheral or interface devices such as a display 434, which may be embodied as a touch screen display in some embodiments. Additionally, in some embodiments, the peripheral devices 432 may include other peripheral devices such as a keyboard, a mouse, external speakers, and/or the like. The peripheral devices 432 are communicatively coupled to the chipset 424 via a number of signal paths thereby allowing the chipset 424 and/or processor 420 to receive inputs from and send outputs to the peripheral devices 432.

Referring back to FIG. 1, as discussed above, the client computing device 400 executes a master application 402 from which one or more secondary applications 450 may be invoked or executed. In the illustrative embodiment, the master application 402 includes a communication module 404 configured to communicate with the content server 300 to receive new or updated secondary applications 450 and/or service the execution of one or more secondary applications 450. The master application 402 also includes a content decode module 406, which is configured to decode the secondary applications 450 for execution. As discussed above, the secondary applications 450 may be encoded by the content management client 200 using a proprietary or other specialized format. Additionally, the master application 402 may include an interface module 408 for displaying information to a user of the client computing device 400. For example, as discussed in more detail below, the secondary applications 450 may be displayed to the user as icons placed on a virtual shelf. The user may interact with the virtual shelf to view the available secondary applications 450 and execute one of the secondary applications 450 by selecting a corresponding icon from the virtual shelf. Of course, it should be appreciated that the communication module 404, the content decode module 406, and the interface module 408 are merely illustrative and, in other embodiments, the master application 402 may include additional, fewer, or other modules.

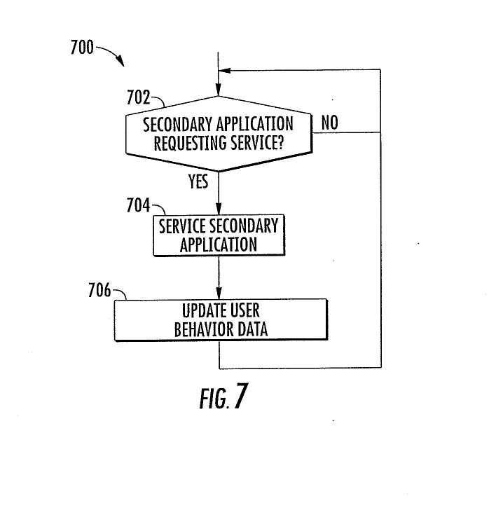

Referring now to FIG. 5, in one embodiment, the content management client 200 may execute a method 500 for generating and updating mobile applications. The method 500 begins with block 502 in which the content management client 200 determines whether a developer user desires to develop or update a secondary application 450. If so, the method 500 advances to block 504 in which the content management client 200 receives secondary application data entered by the developer. That is, in block 504, the developer may interact with the interface module 204 to develop the secondary mobile application 450.

In some embodiments, the content management engine 202 of the content management client 200 includes predefined templates that may be used by the developer to more quickly and efficiently develop secondary applications 450. For example, as shown in FIG. 13, the content management engine 202 may include a various trigger condition templates 1300, such as gesture tap/swipe, device shake, page load, collision/intersection detection, microphone effect, video from device camera, and/or location from location determination circuit (e.g., global positioning system circuit) on device. Additionally, the content management engine 202 may include various trigger action templates 1302 such as translate, location, step, track finger, rotate, angle, and/or scale. Further, in some embodiments, the content management engine 202 may include various animation option templates 1304 such as snap once, continuous ping pong, ping pong once, enabled on start, transition, animate frames, play sound/video, hidden toggle, popup image/text, and various types of window erasure schemes (e.g., cross dissolve). Further, the content management engine 202 may include different trigger target templates 1306 such as self and other. In this way a developer, including a non-technical developer, may develop a secondary application by selecting from the predefined template functionality options to create the final secondary application. Such development may be quicker and more efficient than “hard-coding” individual secondary applications. Of course, it should be appreciated that the templates of FIG. 13 are merely illustrative and, in other embodiments, the content management engine 202 may include fewer, additional, or other templates to facilitate development of the secondary applications 450.

Referring back to FIG. 5, if the development of the new or updated secondary mobile application 450 is completed in block 506, the method 500 advances to block 508. In block 508, the content encode module 206 of the content management engine 202 of the content management client 200 encodes the secondary application data to generate the secondary mobile application 450. Subsequently, in block 510, the new or updated secondary application is uploaded or otherwise transmitted to the content server 300 by the communication module 208 over the network 102 for storage and distribution to the client computing devices 400. As discussed above, the secondary mobile applications 450 developed in this way may be embodied a content secondary applications 452 or advertisement secondary applications 454.

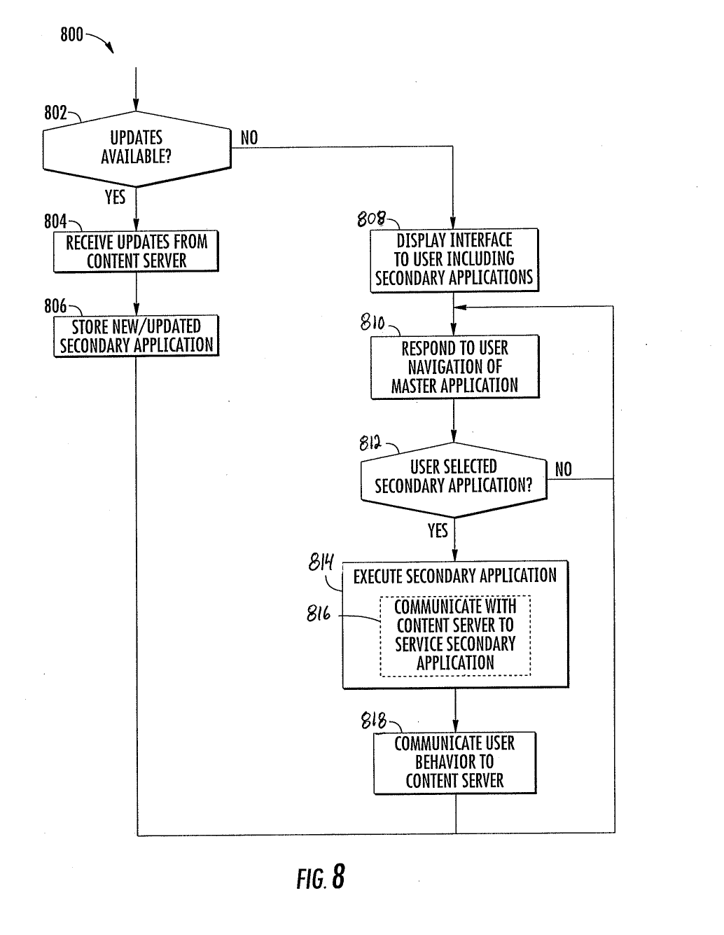

Referring now to FIG. 6, in one embodiment, the content server 300 may execute a method 600 for maintaining and updating secondary mobile applications 450. The method 600 begins with block 602 in which the content server 300 determines if an updated or new secondary application is available from the content management client 200. If so, the method 600 advances to block 604 in which the content server 300 receives the new or updated secondary application 450 from the content management client 200. Subsequently, in block 606, the content server 300 stores the new or updated secondary application in a local database. As discussed above, the secondary applications 450 may be embodied as content secondary applications 452 or as advertisement secondary applications 454.

Referring back to block 602, if no updated or new secondary applications are available, the method 600 advances to block 608 in which the content server 300 determines whether to update the client computing device 400. The content server 300 may make such determinations based on any criteria such as the availability of new or updated secondary applications, the particular user's behavioral data, time elapsed since last update, and/or additional criteria. If the content server 300 determines that an update is required, the method 600 advances to block 610 in which any new or updated secondary applications 450 to be transmitted to the client computing devices 400 (or to specific client computing devices 400) is retrieved from data storage. In some embodiments, new secondary applications 450 are selected by the content server 300 for a particular client computing device based on the respective user's profile and/or past user behavior, which is stored in the user profile and behavior database 312. For example, a 44 year old male user may receive an advertisement secondary application 454 of an alcoholic beverage while a 16 year old female user may receive an advertisement secondary application 452 of a local music store. As discussed above, in some embodiments, the user behavior collected in the database 312 is obtained from the user's interaction with the master application 402 and the secondary application 450. However, in other embodiments, other sources of user behavior, likes/dislikes, or context data (e.g., current location) may be aggregated into the database 312 so as to improve selection of secondary applications 450 of interest. For example, in some embodiments, the content server 300 may be configured to collect, harvest, or otherwise obtain “opt-in” user behavior and/or preference data from other sources such as the user's e-mail account, online social networking accounts, online short messaging accounts, and/or other sources.

Additionally, in some embodiments, the content server 300 may be configured to implement a “rewards system” in which users of the master application 402 and secondary application 450 may accumulate reward points in exchange for registering with the content manager and providing demographic or psychographic in response to survey questions or the like. Such reward points may be subsequently redeemed by the user for content (e.g., particular secondary applications 450) for which the content server 300 would typically charge the user. Of course, it should be appreciated that such “reward system” may award reward points for other activities by the user such as consuming advertiser product through a promotion (e.g., purchasing an advertised product could earn a specific amount of points, persuading other users to purchase content from the content server 300 (which can be can linked to the user's account for reward purposes), performing well on particular secondary applications 450 such as particular games, and/or the like. Further in some embodiments, the accumulated reward points may be redeemable for products directly from participating advertisers (e.g., advertisers of the advertisement secondary applications.) For example, a musical artist may make a particular song available for purchase using standard currency or using the reward points.

In block 612, the content server 300 transfers the new or updated secondary applications to the client computing devices 400. To do so, in some embodiments, the content server 300 may notify the client computing devices 400 (or selected ones of the client computing devices 400) that new or updated secondary applications 450 are available in block 614. The client computing devices 400 (e.g., the master application 402) may subsequently contact that content server 300 to retrieve the available new or updated secondary applications 450. As such, in block 616, the content server 300 may transmit the new of updated secondary applications to the requesting client computing devices 400 in block 616. Additionally, in block 618, the content server 300 may update the user behavior data to reflect the acquisition of the new or updated secondary applications 450 by the individual client computing devices 400.

In should be appreciated that in some embodiments, the master application 402, or components thereof, may also be updated in the method 600. For example, the master application 402 may be updated to a newer version, which may include additional features or the like. Additionally, in some embodiments, additional content libraries used by the master application 402 to execute and interact with particular secondary applications 450 may be updated or otherwise installed into the master application 402 using the method 600. Such additional content libraries may be third-party libraries that provide additional features to the master application 402. For example, an additional content library may be embodied as a three-dimensional game engine, which provides the master application 402 with additional functionality to render graphics and other features of associated secondary application 450. In such embodiments, the content manager 302 may be configured to select corresponding secondary applications 450 based on whether the master application 402 has the additional content libraries installed and/or the master application 402 is of the correct version to execute such “enhanced” secondary application 450. Further, the content management client 200 may include local copies of the additional content libraries, and a suitable interface module 204 update, to allow a developer to develop secondary applications 450 (e.g., 3D games) for use with such additional content libraries.

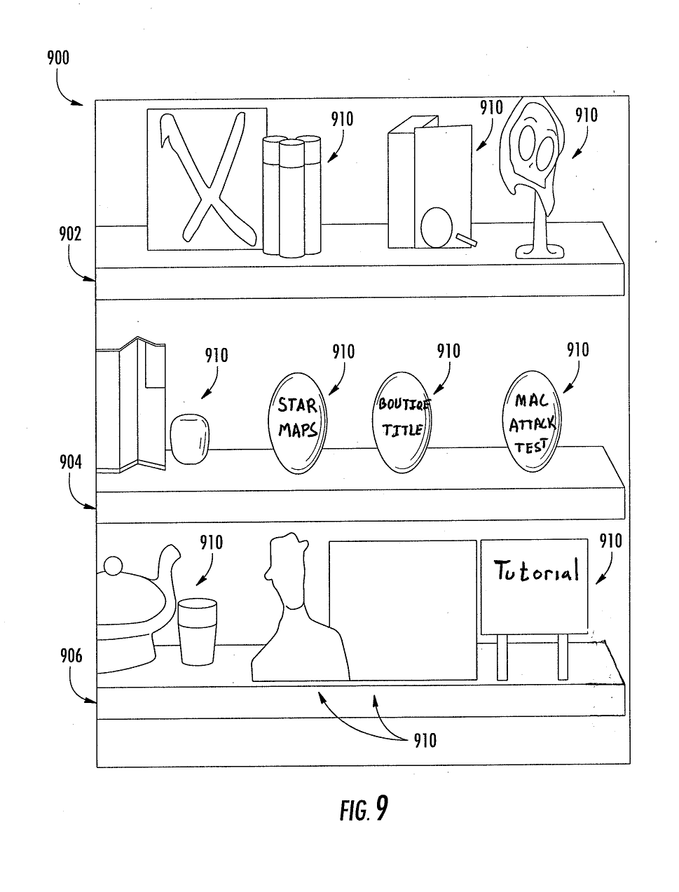

Referring now to FIG. 7, in some embodiments, the content server 300 may also be configured to service particular secondary applications 450 during execution thereof. For example, in some embodiments, one or more of the secondary applications 450 may be embodied as a computer game that may interact with the content server 300 to facilitate the play of such computer game. In such embodiments, the content server 300 may also execute a method 700 for servicing the secondary applications 450. The method 700 begins with block 702 in which the content server 300 determines whether to a secondary application 450 is requesting service. If so, the method 700 advances to block 704 in which the content server 300 services the secondary application 450. The particular types of service provided by the content server 300 may depend on various criteria such as the type of secondary application 450 being executed on the client computing device 400. Subsequently, in block 706, the content server 300 may update the user behavior data for the corresponding client computing device 400 to reflect execution and servicing of the secondary application 450 and any other aspects thereof deemed desirable to monitor.

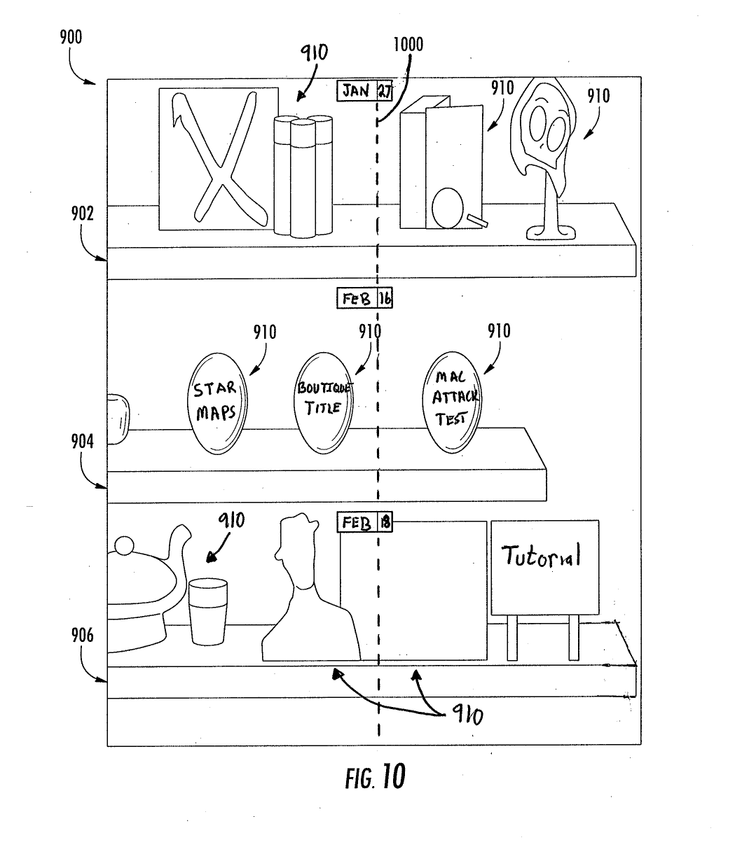

Referring now to FIG. 8, in use, the client computing device(s) 400 may execute a method 800 for retrieving, updating, and executing mobile applications. The method 800 begins with block 802 in which the content master application 402 of the client computing device 400 determines whether any updates are available from the content server 300. As discussed above, the content server 300 may provide a notification to the client computing device 400 that such updates are available in some embodiments. If so, the method 800 advances to block 804 in which the content master application 302 retrieves or otherwise downloads the new or updated secondary applications 450 from the content server 300. Such new or updated secondary applications 450 are subsequently stored locally on the client computing device 400 in block 806. Of course, it should be appreciated that other updates may be retrieved from the content server 300 in this manner. For example, an update to the content master application 302 may be distributed to the client computing device 400 in a similar manner.

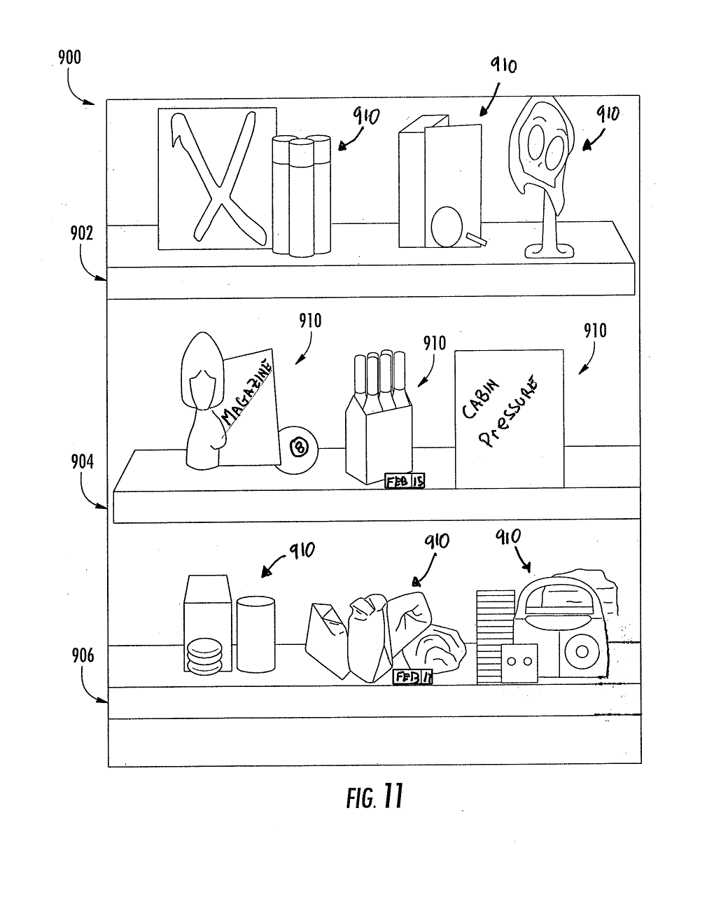

Referring back to block 802, if no updates are available, the method 800 advances to block 808 in which the content master application 302 displays a user interface including indicia of the available secondary applications to the user of the client computing device 400. In the illustrative embodiment, the user interface is embodied as an interactive graphical user interface. For example, in one embodiment as shown in FIG. 9, the user interface 900 is embodied as a plurality of virtual shelves 902, 904, 906 on which icons 910 corresponding to the available secondary applications 450 are placed. Illustratively, the user interface 900 includes three virtual shelves 902, 904, 906, but may include additional or fewer shelves in other embodiments. Additionally, in other embodiments, the user interface 900 may use other virtual structures to display the icons 910.

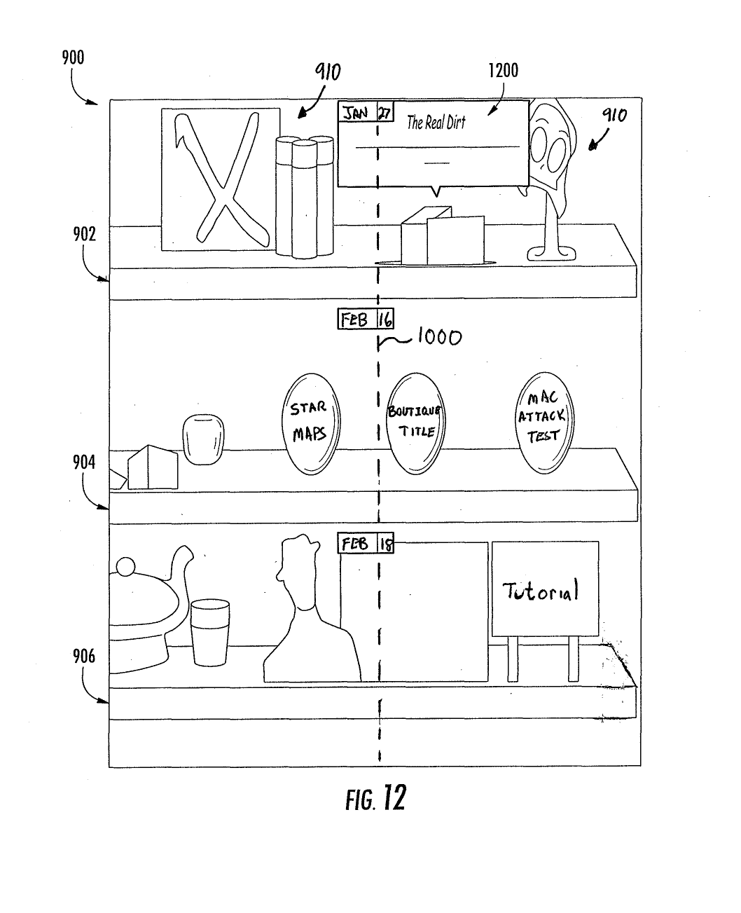

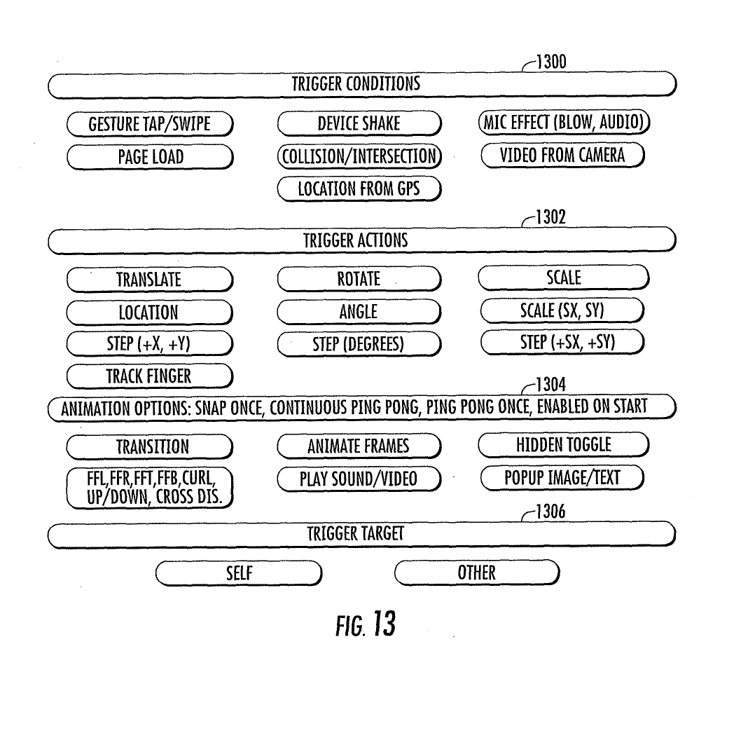

In block 810, the content master application 302 responds to any user navigation or interaction with the virtual shelves 902, 904, 906. For example, in the illustrative embodiment, the user may slide any one of the virtual shelves 902, 904, 906 to the left or right to view additional icons 910 of available secondary applications 450. As shown in FIG. 10, the second virtual shelf 904 has been slid all the way to the left to display a first set of icons 910 corresponding to a first set of available secondary applications 450. Conversely, as shown in FIG. 11, the second virtual shelf 904 has been slid all the way to the right to display a second set of icons 910 corresponding to second set of available secondary applications 450. The icons 910 may be embodied as any type of graphic, text, or other indicia corresponding to the associated secondary application 450. For example, if the secondary application 450 corresponds to an online magazine, the corresponding icon 910 may be embodied as a graphic of the cover of the online magazine. Conversely, if the secondary application 450 corresponds to an advertisement product, the corresponding icon 910 may be embodied as a graphic of the product for sale.

In some embodiments, a timeline 1000 (see FIG. 10) may be displayed to the user as the user interacts with the virtual shelves 902, 904, 906. The timeline 1000 indicates an approximate date of the addition or update of the corresponding secondary application 450. In this way, the user is provided additional information for each of the secondary applications 450. Additionally, as shown in FIG. 12, the user may interact with each individual icon 910 to obtain additional information regarding the corresponding secondary application 450. In the illustrative embodiment, the use may slide the icon 910 downwardly to cause a text box 1200 to appear. The illustrative text box 1200 includes the name of the secondary application 450 and short summary about the secondary application 450. As shown in FIG. 12, as the user slides the icon 910 downwardly, the icon 910 disappears into the corresponding virtual shelf 902, 904, and 906. Of course, other animations may be used in other embodiments.

Referring back to FIG. 8, the master application 402 of the client computing device 400 determines whether the user has selected any of the icons 910 in block 812. If not, the method 800 loops back to block 808 in which the user may continue to interact with the user interface 900 to view the available secondary applications. However, if the user has selected one of the icons 910, the method 800 advances to block 814 in which the master application 402 invokes or otherwise executes the corresponding secondary application 450. As discussed above, in some embodiments, the secondary application 450 may be stored locally on the client computing device 400 and executed directly therefrom. However, in other embodiments, the secondary application 450, or a portion thereof, may be stored remotely on the content server 300. Additionally, in some embodiments, the secondary application 450 may require service by the content server 300 as discussed above. In such embodiments, the client computing device 400 may communicate with the content server 300 to service the secondary application 450 as needed in block 816.

Subsequently, in block 818, the master application 402 may communicate user behavior data to the content server 300. Such user behavior data may be embodied as any type of data indicative of the user's behavior or interaction with the master application 402 and/or the secondary applications. For example, the user behavior data may include which secondary applications were selected, how long the user interacted with the selected secondary applications, how often the user executes the master application, and/or other data related to the master application 402 and/or the secondary applications 450. After any behavior data has been transferred to the content server 300 and the user has completed interaction with the selected secondary application, the method 800 loops back to block 808 in which the user may continue to interact with the master application to view and select the available secondary applications.

It should be appreciated that because the secondary applications 450 are executed by, or otherwise “within,” the master application 402, the secondary applications 450 are portable across various platforms. For example, one master application 402 may be developed for a particular platform (e.g., the iOS operating system devices) and a second master application 402 may be developed for another platform (e.g., the Android operating system devices), each of which may execute the same secondary applications 450. In this way, creation of different secondary applications 450 for each platform is not needed and such secondary applications 450 may be executed on any one of a number of different platforms from a master application 402 developed for that particular platform.

There is a plurality of advantages of the present disclosure arising from the various features of the apparatuses, circuits, and methods described herein. It will be noted that alternative embodiments of the apparatuses, circuits, and methods of the present disclosure may not include all of the features described yet still benefit from at least some of the advantages of such features. Those of ordinary skill in the art may readily devise their own implementations of the apparatuses, circuits, and methods that incorporate one or more of the features of the present disclosure and fall within the spirit and scope of the present invention as defined by the appended claims.

1. (canceled)

2. The method of claim 10, wherein displaying a plurality of icons on the display of the mobile computing device comprises displaying a virtual shelf and displaying the plurality of icons on the virtual shelf.

3. The method of claim 2, further comprising:
detecting a user's interaction with the virtual shelf and
moving the virtual shelf to display additional secondary mobile applications available for selection by the user.

4. A method for executing a mobile application on a mobile computing device, the method comprising:
executing a master mobile application on a mobile computing device;
displaying a virtual shelf on a display of the mobile computing device,
displaying a plurality of icons on the virtual shelf, each icon representing a secondary mobile application that may be invoked from the master mobile application;
executing a secondary mobile application from the master mobile application in response to a user selecting a corresponding icon of the plurality of icons;
detecting a user's interaction with the virtual shelf; and
moving the virtual shelf to display additional secondary mobile applications available for selection by the user; and
displaying date information in association with each secondary mobile applications indicative of the last update date of the corresponding secondary mobile application.

5. A method for executing a mobile application on a mobile computing device, the method comprising:
executing a master mobile application on a mobile computing device;
displaying a virtual shelf on a display of the mobile computing device,
displaying a plurality of icons on the virtual shelf, each icon representing a secondary mobile application that may be invoked from the master mobile application;
executing a secondary mobile application from the master mobile application in response to a user selecting a corresponding icon of the plurality of icons;
detecting a user's interaction with a selected secondary mobile application displayed on the virtual shelf; and
in response to the user's interaction matching a predetermined interaction, displaying text information regarding the selected secondary mobile application in place of the icon corresponding to the selected secondary mobile application.

6. The method of claim 10, wherein executing the secondary mobile application comprises communicating with a remote server over a network to service the secondary mobile application.

7. The method of claim 10, wherein executing the secondary mobile application comprises downloading a secondary mobile application from a remote server.

8. The method of claim 10, wherein executing a secondary mobile application comprises executing a secondary content mobile application.

9. The method of claim 10, wherein executing a secondary mobile application comprises executing a secondary advertisement mobile application.

10. A method for executing a mobile application on a mobile computing device, the method comprising:
executing a master mobile application on a mobile computing device;
displaying a plurality of icons on a display of the mobile computing device, each icon representing a secondary mobile application that may be invoked from the master mobile application;
executing a secondary mobile application from the master mobile application in response to a user selecting a corresponding icon of the plurality of icons;
generating user behavior data on the mobile computing device associated with at least one secondary mobile application; and
transmitting the generated user behavior data to the remote server.

11. The method of claim 10, further comprising receiving an updated secondary mobile application from a remote server and storing the updated secondary mobile application on the mobile computing device.

12. (canceled)

13. A method for executing a mobile application on a mobile computing device, the method comprising:
executing a master mobile application on a mobile computing device;
displaying a plurality of icons on a display of the mobile computing device, each icon representing a secondary mobile application that may be invoked from the master mobile application;
executing a secondary mobile application from the master mobile application in response to a user selecting a corresponding icon of the plurality of icons.
receiving an update notification from a remote server;
communicating with the remote server in response to the update notification;
retrieving an updated secondary mobile application from the remote server;
wherein the updated secondary mobile application comprises a secondary mobile application selected by the remote server based on user behavior data associated with a user of the mobile computing device.

14. The method of claim 13, wherein the user behavior data comprises user behavior data collected on the mobile computing device.

15. The method of claim 14, wherein the user behavior data comprises user behavior data collected from sources remote to the mobile computing device.

16. A method for executing a mobile application on a mobile computing device, the method comprising:
executing a master mobile application on a mobile computing device;
displaying a plurality of icons on a display of the mobile computing device, each icon representing a secondary mobile application that may be invoked from the master mobile application;
executing a secondary mobile application from the master mobile application in response to a user selecting a corresponding icon of the plurality of icons;
receiving an update notification from a remote server;
communicating with the remote server in response to the update notification; and
retrieving a content library from the remote server, the content library updating the master mobile application to allow the master mobile application to execute additional secondary mobile applications have features supported by the content library.

17. The method of claim 10, wherein the master mobile application is platform-dependent and the secondary mobile application is platform-independent.

18. (canceled)

19. The mobile computing device of claim 27, wherein displaying a plurality of icons on the display of the mobile computing device comprises displaying a virtual shelf and displaying the plurality of icons on the virtual shelf.

20. The mobile computing device of claim 19, wherein the plurality of instruction further result in the processor:
detecting a user's interaction with the virtual shelf; and
moving the virtual shelf to display additional secondary mobile applications available for selection by the user.

21. A mobile computing device comprising:
a processor; and
a memory device communicatively coupled to the processor, the memory device having a plurality of instructions stored therein that result in the processor:
executing a master mobile application on the mobile computing device;
displaying a virtual shelf on a display of the mobile computing device,
displaying a plurality of icons on the virtual shelf, each icon representing a secondary mobile application that may be invoked from the master mobile application;
executing a secondary mobile application from the master mobile application in response to a user selecting a corresponding icon of the plurality of icons;
detecting a user's interaction with the virtual shelf;
moving the virtual shelf to display additional secondary mobile applications available for selection by the user; and
displaying date information in association with each secondary mobile applications indicative of the last update date of the corresponding secondary mobile application.

22. A mobile computing device comprising:
a processor; and
a memory device communicatively coupled to the processor, the memory device having a plurality of instructions stored therein that result in the processor:
executing a master mobile application on the mobile computing device;
displaying a virtual shelf on a display of the mobile computing device,
displaying a plurality of icons on the virtual shelf, each icon representing a secondary mobile application that may be invoked from the master mobile application;
executing a secondary mobile application from the master mobile application in response to a user selecting a corresponding icon of the plurality of icons;
detecting a user's interaction with a selected secondary mobile application displayed on the virtual shelf; and
in response to the user's interaction matching a predetermined interaction, displaying text information regarding the selected secondary mobile application in place of the icon corresponding to the selected secondary mobile application.

23. The mobile computing device of claim 27, wherein executing the secondary mobile application comprises communicating with a remote server over a network to service the secondary mobile application.

24. The mobile computing device of claim 27, wherein executing the secondary mobile application comprises downloading a secondary mobile application from a remote server.

25. The mobile computing device of claim 27, wherein executing a secondary mobile application comprises executing a secondary content mobile.

26. The mobile computing device of claim 27, wherein executing a secondary mobile application comprises executing a secondary advertisement mobile application.

27. A mobile computing device comprising:
a processor; and
a memory device communicatively coupled to the processor, the memory device having a plurality of instructions stored therein that result in the processor:
executing a master mobile application on the mobile computing device;
displaying a plurality of icons on a display of the mobile computing device, each icon representing a secondary mobile application that may be invoked from the master mobile application;
executing a secondary mobile application from the master mobile application in response to a user selecting a corresponding icon of the plurality of icons;
generating user behavior data on the mobile computing device associated with at least one secondary mobile application; and
transmitting the generated user behavior data to the remote server.

28. The mobile computing device of claim 27, wherein the plurality of instruction further result in the processor receiving an updated secondary mobile application from a remote server and storing the updated secondary mobile application on the mobile computing device.

29. (canceled)

30. A mobile computing device comprising:
a processor; and
a memory device communicatively coupled to the processor, the memory device having a plurality of instructions stored therein that result in the processor:
executing a master mobile application on the mobile computing device;
displaying a plurality of icons on a display of the mobile computing device, each icon representing a secondary mobile application that may be invoked from the master mobile application;
executing a secondary mobile application from the master mobile application in response to a user selecting a corresponding icon of the plurality of icons;
receiving an update notification from a remote server;
communicating with the remote server in response to the update notification; and
retrieving an updated secondary mobile application from the remote server,
wherein the updated secondary mobile application comprises a secondary mobile application selected by a remote server based on user behavior data associated with a user of the mobile computing device.

31. The mobile computing device of claim 30, wherein the user behavior data comprises user behavior data collected on the mobile computing device.

32. The mobile computing device of claim 31, wherein the user behavior data comprises user behavior data collected from sources remote to the mobile computing device.

33. A mobile computing device comprising:
a processor; and
a memory device communicatively coupled to the processor, the memory device having a plurality of instructions stored therein that result in the processor:
executing a master mobile application on the mobile computing device;
displaying a plurality of icons on a display of the mobile computing device, each icon representing a secondary mobile application that may be invoked from the master mobile application;
executing a secondary mobile application from the master mobile application in response to a user selecting a corresponding icon of the plurality of icons;
receiving an update notification from a remote server;
communicating with the remote server in response to the update notification; and
retrieving an content library from the remote server, the content library updating the master mobile application to allow the master mobile application to execute additional secondary mobile applications have features supported by the content library.

34. The mobile computing device of claim 27, wherein the master mobile application is platform-dependent and the secondary mobile application is platform-independent.

35. (canceled)

36. The machine readable media of claim 44, wherein the plurality of instruction further result in the processor displaying a plurality of icons on the display of the mobile computing device comprises displaying a virtual shelf and displaying the plurality of icons on the virtual shelf.

37. The machine readable media of claim 36, wherein the plurality of instruction further result in the processor:
detecting a user's interaction with the virtual shelf; and
moving the virtual shelf to display additional secondary mobile applications available for selection by the user.

38. At least one machine readable media comprising a plurality of instructions, which in response to being executed by a mobile computing device, result in the mobile computing device:
executing a master mobile application on the mobile computing device;
displaying a virtual shelf on a display of the mobile computing device,
displaying a plurality of icons on the virtual shelf, each icon representing a secondary mobile application that may be invoked from the master mobile application;
executing a secondary mobile application from the master mobile application in response to a user selecting a corresponding icon of the plurality of icons;
detecting a user's interaction with the virtual shelf;
moving the virtual shelf to display additional secondary mobile applications available for selection by the user; and
displaying date information in association with each secondary mobile applications indicative of the last update date of the corresponding secondary mobile application.

39. At least one machine readable media comprising a plurality of instructions, which in response to being executed by a mobile computing device, result in the mobile computing device:
executing a master mobile application on the mobile computing device;
displaying a virtual shelf on a display of the mobile computing device,
displaying a plurality of icons on the virtual shelf, each icon representing a secondary mobile application that may be invoked from the master mobile application; and
executing a secondary mobile application from the master mobile application in response to a user selecting a corresponding icon of the plurality of icons;
detecting a user's interaction with a selected secondary mobile application displayed on the virtual shelf; and
in response to the user's interaction matching a predetermined interaction, displaying text information regarding the selected secondary mobile application in place of the icon corresponding to the selected secondary mobile application.

40. The machine readable media of claim 44, wherein executing the secondary mobile application comprises communicating with a remote server over a network to service the secondary mobile application.

41. The machine readable media of claim 44, wherein executing the secondary mobile application comprises downloading a secondary mobile application from a remote server.

42. The machine readable media of claim 44, wherein executing a secondary mobile application comprises executing a secondary content mobile application.

43. The mobile computing device of claim 44, wherein executing a secondary mobile application comprises executing a secondary advertisement mobile application.

44. At least one machine readable media comprising a plurality of instructions, which in response to being executed by a mobile computing device, result in the mobile computing device:
executing a master mobile application on the mobile computing device;
displaying a plurality of icons on a display of the mobile computing device, each icon representing a secondary mobile application that may be invoked from the master mobile application;
executing a secondary mobile application from the master mobile application in response to a user selecting a corresponding icon of the plurality of icons;
generating user behavior data on the mobile computing device associated with at least one secondary mobile application; and
transmitting the generated user behavior data to the remote server.

45. The machine readable media of claim 44, wherein the plurality of instruction further result in the processor receiving an updated secondary mobile application from a remote server and storing the updated secondary mobile application on the mobile computing device.

46. (canceled)

47. At least one machine readable media comprising a plurality of instructions, which in response to being executed by a mobile computing device, result in the mobile computing device:
executing a master mobile application on the mobile computing device;
displaying a plurality of icons on a display of the mobile computing device, each icon representing a secondary mobile application that may be invoked from the master mobile application; and
executing a secondary mobile application from the master mobile application in response to a user selecting a corresponding icon of the plurality of icons;
receiving an update notification from a remote server;
communicating with the remote server in response to the update notification; and
retrieving an updated secondary mobile application from the remote server;
wherein the updated secondary mobile application comprises a secondary mobile application selected by the remote server based on user behavior data associated with a user of the mobile computing device.

48. The machine readable media of claim 47, wherein the user behavior data comprises user behavior data collected on the mobile computing device.

49. The machine readable media of claim 48, wherein the user behavior data comprises user behavior data collected from sources remote to the mobile computing device.

50. At least one machine readable media comprising a plurality of instructions, which in response to being executed by a mobile computing device, result in the mobile computing device:
executing a master mobile application on the mobile computing device;
displaying a plurality of icons on a display of the mobile computing device, each icon representing a secondary mobile application that may be invoked from the master mobile application;
executing a secondary mobile application from the master mobile application in response to a user selecting a corresponding icon of the plurality of icons
receiving an update notification from a remote server;
communicating with the remote server in response to the update notification; and
retrieving an content library from the remote server, the content library updating the master mobile application to allow the master mobile application to execute additional secondary mobile applications have features supported by the content library.

51. The machine readable media of claim 44, wherein the master mobile application is platform-dependent and the secondary mobile application is platform-independent.

52. A method for delivering content to a mobile computing device, the method comprising:
selecting at least one trigger condition template from a library of trigger condition templates;
selecting at least one trigger action template from a library of trigger action templates to result from the occurrence of the trigger condition template; and
generating a secondary application as a function of the selected templates, the secondary application being executable from a master mobile application.

53. The method of claim 52, wherein the library of trigger condition templates includes one of a gesture template, a page load template, a device shake template, a collision/intersection detection template, a microphone effect template, a video from camera template, or a location determination template.

54. The method of claim 52, wherein the library of trigger action templates includes one of a translate template, a location template, a step template, a track finger template, a rotate template, an angle template, and a scale template.

55. The method of claim 52, further comprising displaying the library of trigger condition templates and the library of trigger action templates.

56. The method of claim 52, wherein generating the secondary application comprises generating source code executable by the master mobile application as a function of the selected templates.
